(19) United States
(12) Patent Application Publication
(10) Pub. No.: US 2012/0075760 A1
(43) Pub. Date: Mar. 29, 2012

(54) PROTECTION OF AN ELECTRONIC EQUIPMENT

(75) Inventor: François ROBERT, CHANCEAUX SUR CHOISILLE (FR)

(73) Assignee: THALES, NEUILLY SUR SEINE (FR)

(21) Appl. No.: 13/078,045

(22) Filed: Apr. 1, 2011

(30) Foreign Application Priority Data
Apr. 2, 2010 (FR) FR1001393

(51) Int. Cl. H02H 3/20; H02H 3/08; H02H 3/06

(52) U.S. Cl. 361/86; 361/91.2; 361/93.4

(57) ABSTRACT

A device for protecting electronic equipment having an output terminal includes an electronic breaker switch linked between the output terminal and ground, and a protection means which protects the electronic breaker switch against overvoltages applied to the output terminal. The protection means includes a means for detecting a current above a given threshold flowing in the electronic breaker switch, a means for prohibiting the closing of the electronic breaker switch when the current flowing in the electronic breaker switch is above the given threshold, and a means for permitting the closing of the electronic breaker switch after a given duration following a prohibition.

### CROSS-REFERENCE TO RELATED APPLICATION

This application claims priority to foreign French patent application No. FR 10 01393, filed on Apr. 2, 2010, the disclosure of which is incorporated by reference in its entirety.

### FIELD OF THE INVENTION

The invention relates to the protection of electronic equipment against possible overvoltages applied to terminals thereof and, more precisely, to possible overvoltages applied to output terminals of the equipment.

### BACKGROUND OF THE INVENTION

Aboard aircraft, for example, standard supply networks deliver 28V DC, or 115V AC voltages at a frequency of 400 Hz. The application of such voltages directly to an output terminal of electronic equipment has a tendency to destroy components of the electronic equipment associated with the output terminal. The application of the voltages may be due, for example, to a failure of another piece of equipment intended to dialogue with the equipment through the output terminal.

At present, protection of the output terminal is attempted by means of a diode, called Transient Voltage Suppressor diode, or TVS diode, connected between the output terminal and an electrical earth, e.g., ground, of the equipment, as well as by a fuse connected in series between the output terminal and the components of the equipment that are associated with this terminal. This protection is in place to attempt to avoid destruction of the components. Nonetheless, in the event of an overvoltage, the fuse and the diode are destroyed and require an intervention on the equipment. Moreover, a TVS diode cannot be tested without the application of a calibrated voltage wave to the diode. This application is difficult and cannot be carried out without removing the equipment, such as during a maintenance operation. In equipment aboard aircraft, maintenance operations are scheduled with an occurrence of every several thousand hours, for example. It is therefore possible for a situation to arise in which the TVS diode is out of service with no possibility of this being discovered. Moreover, in the event of doubt regarding the operation of the TVS diode, the equipment has to be reinstalled to test the TVS diode, thus requiring the replacement of the equipment to prevent immobilizing the aircraft. This replacement entails significant costs and efforts.

### SUMMARY OF THE INVENTION

Embodiments of the invention alleviate at least the problems described above by providing a way of protecting an output terminal of electronic equipment without requiring the use of a fuse and/or a TVS diode. The invention finds utility in electronic equipment, such as equipment aboard aircraft, for example, that could be subjected to lightning, or to which supply voltages might be inadvertently applied to the output terminal.

As used herein, the expression output terminal is understood to mean a terminal at which an item of information exits the equipment.

The present invention provides protection for electronic equipment, having an output terminal, including an electronic breaker switch linked between the output terminal and an earth, e.g., ground, of the equipment, and means for protecting the electronic breaker switch against possible overvoltages applied to the output terminal. The protection means includes means for detecting a current above a given threshold flowing in the electronic breaker switch and means for prohibiting the closing of the electronic breaker switch when the current flowing in the electronic breaker switch is above the given threshold.

In an embodiment, the protection means includes means for permitting the closing of the electronic breaker switch after a given duration following a prohibition. This duration is fixed and begins at the start of the prohibition.

The invention allows frequent testing of the means for protecting the electronic breaker switch without requiring the removal of the equipment, such as by simulating a current above the given threshold, for example. This test operation can be performed each time the equipment is powered up, or even on a simple request from an operator, for example, in the event of doubt regarding the fact that there has been an overvoltage.

One or more embodiments of the invention also avoid the required use of a fuse. Therefore, changing a fuse is not required after the occurrence of an overvoltage.

### BRIEF DESCRIPTION OF THE DRAWINGS

The invention will be better understood and the above and other aspects, features, and advantages will become more apparent by reading the accompanying detailed description, given by way of example, and in view of the appended drawing, in which:

FIG. 1 represents an exemplary basic diagram implementing the invention; and

FIG. 2 represents a more complete diagram implementing the invention.

For the sake of clarity, the same elements will bear the same labels in the various figures.

### DETAILED DESCRIPTION

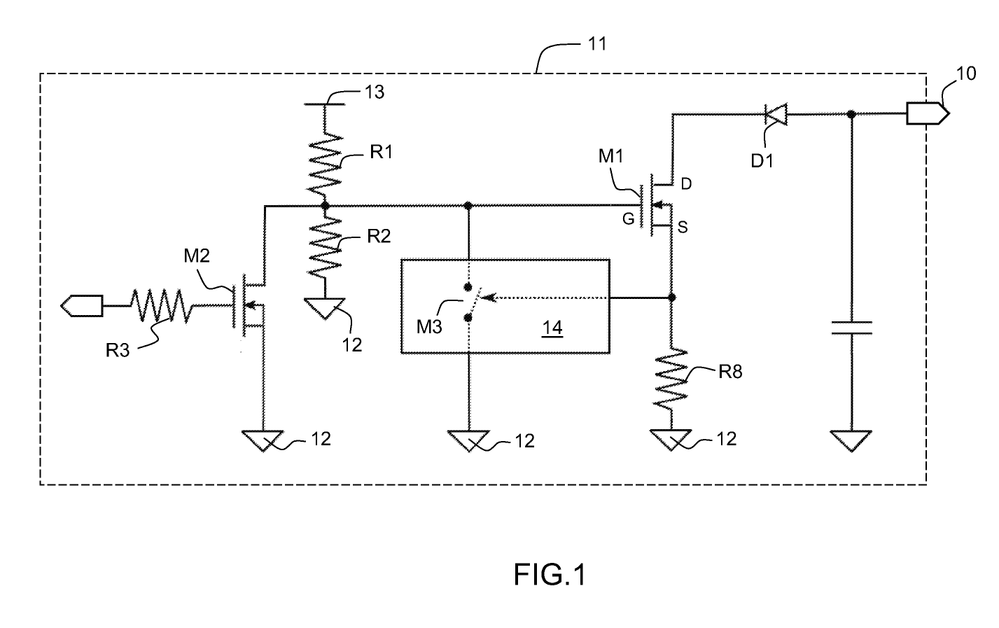

FIG. 1 represents components associated with an output terminal 10 of an electronic equipment 11. During normal operation, e.g., in the absence of an overvoltage, the output terminal 10 may be either linked to an earth 12, e.g., a ground 12, of the equipment 11 or isolated. Linking to the earth 12 is done by means of an electronic breaker switch M1 formed, for example, by a negative-channel field-effect transistor. The drain, denoted D, of the transistor M1 is connected to the terminal 10 by way of a diode D1 making it possible to permit the flow of the current only from the terminal 10 to the earth 12. The source, denoted S, of the transistor M1 is connected to the earth 12 by way of a resistor R8 allowing the measurement of current flowing in the electronic breaker switch M1 between its drain D and its source S.

The electronic breaker switch M1 is controlled by its gate, denoted G. More precisely, when the voltage between gate G and source S of the transistor M1 has a low value, the electronic breaker switch is open. Stated otherwise the transistor M1 is off. When the voltage between gate G and source S of the transistor M1 has a high value, the electronic breaker switch is closed. Stated otherwise the transistor M1 is on.

During normal operation, to deliver an item of information at the output terminal 10, the gate G of the transistor M1 is controlled by a second electronic breaker switch, for example formed by a negative-channel field-effect transistor M2, making it possible to optionally link the gate G of the transistor M1 to the earth 12. When the second breaker switch M2 is open, the gate G voltage of the transistor M1 is at a high voltage value which is for example fixed by a voltage divider formed by two resistors R1 and R2. The resistor R1 is connected between a positive supply voltage 13 of the equipment 11 and the gate G of the transistor M1. The resistor R2 is connected between the gate G of the transistor M1 and the earth 12. For this high value of gate G voltage, the transistor M1 is on.

When the transistor M2 is on, the gate G voltage of the transistor M1 is low. This voltage is about that of the earth 12. For this low value of gate G voltage, the transistor M1 is off.

The transistor M2 is for example driven by its gate by way of a resistor R3 by means of a programmable logic circuit not represented in FIG. 1.

It was seen above that the resistor R8 allows the measurement of the current flowing in the breaker switch M1 between its drain D and its source S. The common point of the transistor M1 and of the resistor R8, that is to say the source S of the transistor M1, makes it possible to drive protection means 14 for the breaker switch M1. The protection means 14 comprise a third breaker switch M3 making it possible to connect the gate G of the transistor M1 to the earth 12 in the event of an overvoltage occurring at the level of the output terminal 10. More precisely, an overvoltage present on the output terminal 10 when the breaker switch M1 is closed causes the voltage across the terminals of the resistor R8 to climb. The comparison of this voltage with a predefined threshold makes it possible to control the breaker switch M3. As long as the voltage across the terminals of the resistor R8 remains below the predefined threshold, the breaker switch M3 remains open and the transistor M1 is driven by the transistor M2. On the other hand, if the voltage across the terminals of the resistor R8 rises beyond the threshold, the breaker switch M3 closes and forces the transistor M1 to turn off. The measurement of current flowing in the resistor R8 takes place only when the transistor M1 is on. When the transistor M2 turns off the transistor M1, the measurement of current flowing in the resistor R8 is not performed. This absence of measurement does not have any consequence since, once turned off, the transistor M1 is not sensitive to any overvoltage.

By using the resistor R8, placed between the source S of the transistor M1 and the earth 12, to measure the current flowing in the breaker switch M1, it is possible, at the moment of the occurrence of an overvoltage on the terminal 10, to cause the potential present at the source S of the field-effect transistor M1 to climb. This increase in potential reduces the potential difference between the gate G and the source S of the transistor M1, thereby increasing the internal resistance of the transistor M1 between its drain D and its source S. This drop in conduction of the transistor M1 constitutes a first protection of the transistor M1. This protection remains partial and is insufficient to open the breaker switch M1 completely. Complete opening is obtained by means of the breaker switch M3.

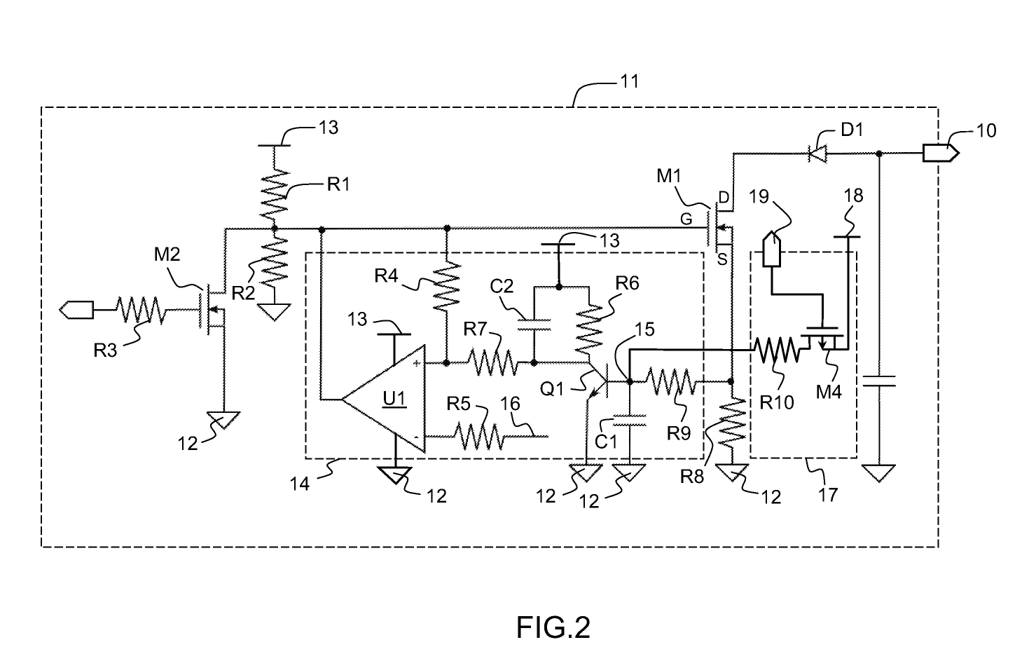

FIG. 2 represents a more complete diagram implementing the invention. Depicted once again are the transistors M1 and M2, the diode D1, the divider bridge formed by the resistors R1 and R2 and the resistors R3 and R8. An exemplary embodiment of the protection means 14 is represented in greater detail in FIG. 2. The protection means 14 comprise a low-pass filter making it possible to filter the detection of the current flowing in the electronic breaker switch M1 so as to prevent overvoltages of too small a duration from prohibiting the closing of the electronic breaker switch M1. The low-pass filter comprises for example a resistor R9 and a capacitor C1 linked in series between the source S of the transistor M1 and the earth 12. A common point 15 of the resistor R9 and of the capacitor C1 forms the output of the low-pass filter.

The voltage present at the point 15 is inverted and amplified by means of a bipolar transistor Q1, the base of which is linked to the point 15, the emitter to the earth 12 and the collector to the positive supply voltage 13 by way of a resistor R6 and of a capacitor C2 arranged in parallel.

The collector of the transistor Q1 is linked to a positive input of a comparator U1 by way of a resistor R7. The positive input of the comparator U1 is moreover linked to the gate of the transistor M1 by way of a resistor R4. A negative input of the comparator U1 is linked to a reference voltage 16 by way of a resistor R5. The reference voltage 16 forms a threshold making it possible to define the maximum current flowing in the resistor R8, beyond which it is necessary to force the transistor M1 to turn off so as to ensure its protection.

The output of the comparator U1 is linked to the gate G of the transistor M1. The output of the comparator M1 is either open or connected to the earth as a function of the potential difference between its positive and negative inputs. This type of comparator is known in the literature by the name “open/ground”. The comparator U1 forms the breaker switch M3 represented in FIG. 1. The comparator U1 compares an image of the voltage across the terminals of the resistor R8 with the reference voltage 16. The image of the voltage across the terminals of the resistor R8 is the voltage present at the level of the collector of the transistor Q1. The output of the comparator U1 is either open or connected to the earth as a function of the result of the comparison between the image of the voltage across the terminals of the resistor R8 and the reference voltage 16.

More precisely, when the current flowing in the source S of the transistor M1 remains below the tolerable threshold for this transistor, stated otherwise when the voltage across the terminals of the resistor R8 remains below a given value, the transistor Q1 is off, the potential of the positive input of the comparator U1 remains above the reference voltage 16 present on the negative input of the comparator U1 and the output of the comparator U1 is in the open state. In this case, the transistor M1 may be driven normally by the transistor M2.

In the converse case, when the current flowing in the resistor R8 goes above the tolerable threshold for the transistor M1, the transistor Q1 turns on, the potential of the positive input of the comparator U1 becomes less than the reference voltage 16 present on the negative input of the comparator U1, the voltage present on the output of the comparator U1 is about that of the earth 12, thereby forcing the gate G voltage of the transistor M1 to the voltage of the earth 12.

When the gate G voltage of the transistor M1 is forced to the earth 12, the current flowing in the resistor R8 vanishes thereby interrupting the forcing to the earth of the gate G of the transistor M1. To avoid too fast an interruption of the forcing, the protection means advantageously comprise means for permitting the closing of the electronic breaker switch M1, that is to say for interrupting the forcing, after a given duration following a prohibition. This given duration begins at the instant at which the prohibition starts. The given duration is fixed. It is defined by means of passive components and more precisely by means of the value of the capacitor C2 in conjunction with the values of the resistors R4, R6 and R7 which make it possible to defer the return to the normal state of the equipment, that is to say with no forcing of the gate G of the transistor M1.

Advantageously, the equipment 11 comprises test means 17 for the protection means 14. The test means 17 make it possible to force the image of the voltage across the terminals of the resistor R8 to a value obtained in the event of an overvoltage applied to the output terminal 10.

The test means 17 make it possible for the base potential of the bipolar transistor Q1 to be taken to a voltage sufficient to turn it on independently of the current flowing in the resistor R8 and therefore without calling upon an overvoltage on the terminal 10. The test means 17 comprise for example a positive-channel field-effect transistor M4 whose drain is linked to the point 15 by way of a resistor R10, whose source is linked to a voltage source 18 which may be used for logic applications of the electronic equipment 11, such as for example a voltage source of 3.3V. The gate of the transistor M4 is linked to a terminal 19 of a logic circuit that can deliver either a voltage of 3.3V or a voltage of 0V. More generally, the transistor M4 forms an electronic breaker switch making it possible to force the turning on of the bipolar transistor Q1.

When it is not desired to perform any test on the protection means 14, a logic voltage of 3.3V is applied to the gate of the transistor M4 and opens the latter. The voltage of the point 15 is then formed solely across the resistor R9 and only an overvoltage applied to the terminal 10 can turn on the transistor Q1.

On the other hand, when it is desired to perform a test on the protection means 14, a zero logic voltage is applied to the gate of the transistor M4 and the transistor M4 turns on. It makes it possible to apply to the point 15 the voltage of the source 18 across the resistor R9, thereby forcing the transistor Q1 to turn on and taking the gate voltage of the transistor M1 to the earth 12 by way of the comparator U1.

What is claimed is:

1. A device for protecting electronic equipment having an output terminal, said device comprising:
an electronic breaker switch linked between the output terminal and ground; and
a protection means which protects the electronic breaker switch against overvoltages applied to the output terminal, wherein
the protection means comprises means for detecting a current above a given threshold flowing in the electronic breaker switch, means for prohibiting the closing of the electronic breaker switch when the current flowing in the electronic breaker switch is above the given threshold, and means for permitting the closing of the electronic breaker switch after a given duration following a prohibition.

2. The device according to claim 1, wherein the protection means further comprises a low-pass filter which filters the detection of the current flowing in the electronic breaker switch to prevent overvoltages of a small duration from prohibiting the closing of the electronic breaker switch.

3. The device according to claim 1, wherein
the electronic breaker switch is a negative-channel field-effect transistor linked to the output terminal by a drain thereof, linked to the ground by a source thereof, and controlled by a gate thereof, and
the protection means further comprises means for linking the gate of the field-effect transistor to the ground.

4. The device according to claim 3, wherein the means for detecting the current comprises:
a resistor connected between the source of the field-effect transistor and the ground; and
means for controlling the means for linking the gate of the field-effect transistor to the ground when the voltage across the terminals of the resistor, forming an image of the current flowing in the electronic breaker switch, exceeds a voltage corresponding to the given threshold of current.

5. The device according to claim 4, wherein
the means for controlling the means for linking the gate of the field-effect transistor to the ground comprises a comparator which compares an image of the voltage across the terminals of the resistor with a reference voltage,
an output of the comparator is linked to the gate of the transistor,
the output of the comparator is one of open and connected to the ground as a function of the result of the comparison between the image of the voltage across the terminals of the resistor and the reference voltage.

6. The device according to claim 1, further comprising a test means for the protection means.

7. The device according to claim 5, wherein the test means for the protection means forces the image of the voltage across the terminals of the resistor to a value obtained in the event of an overvoltage applied to the output terminal.

8. The device according to claim 6, wherein the test means for the protection forces the image of the voltage across the terminals of the resistor to a value obtained in the event of an overvoltage applied to the output terminal.

9. A device for protecting electronic equipment having an output terminal, said device comprising:
an electronic breaker switch linked between the output terminal and ground; and
a protection part which protects the electronic breaker switch against overvoltages applied to the output terminal, wherein
the protection part comprises a part for detecting a current above a given threshold flowing in the electronic breaker switch, a part for prohibiting the closing of the electronic breaker switch when the current flowing in the electronic breaker switch is above the given threshold, and a part which permits the closing of the electronic breaker switch after a given duration following a prohibition.

10. The device according to claim 9, wherein the protection part further comprises a low-pass filter which filters the detection of the current flowing in the electronic breaker switch to prevent overvoltages of a small duration from prohibiting the closing of the electronic breaker switch.

11. The device according to claim 9, wherein
the electronic breaker switch is a negative-channel field-effect transistor linked to the output terminal by a drain thereof, linked to the ground by a source thereof, and controlled by a gate thereof, and
the protection part further comprises a part for linking the gate of the field-effect transistor to the ground.

12. The device according to claim 11, wherein the part for detecting the current comprises:
a resistor connected between the source of the field-effect transistor and the ground; and
a part for controlling the means for linking the gate of the field-effect transistor to the ground when the voltage across the terminals of the resistor, forming an image of the current flowing in the electronic breaker switch, exceeds a voltage corresponding to the given threshold of current.

13. The device according to claim 12, wherein
the part for controlling the means for linking the gate of the field-effect transistor to the ground comprises a comparator which compares an image of the voltage across the terminals of the resistor with a reference voltage,
an output of the comparator is linked to the gate of the transistor,
the output of the comparator is one of open and connected to the ground as a function of the result of the comparison between the image of the voltage across the terminals of the resistor and the reference voltage.

14. The device according to claim 9, further comprising a test part for the protection part.

15. The device according to claim 13, wherein the test part for the protection part forces the image of the voltage across the terminals of the resistor to a value obtained in the event of an overvoltage applied to the output terminal.

16. The device according to claim 14, wherein the test part for the protection part the image of the voltage across the terminals of the resistor to a value obtained in the event of an overvoltage applied to the output terminal.
